(19) United States
(12) Patent Application Publication
(10) Pub. No.: US 2026/0320084 A1
(43) Pub. Date: Oct. 15, 2026

(54) Query Expansion by Prompting Large Language Models

(71) Applicant: Google LLC, Mountain View, CA (US)

(72) Inventors: Rolf Jagerman, New York, NY (US); Honglei Zhuang, Santa Clara, CA (US); Zhen Qin, Jersey City, NJ (US); Michael Bendersky, Cupertino, CA (US); Xuanhui Wang, Cupertino, CA (US)

(21) Appl. No.: 19/481,072

(22) PCT Filed: May 3, 2024
(86) PCT No.: PCT/US2024/027712

§ 371 Date: Nov. 3, 2025

Related U.S. Application Data
(60) Provisional application No. 63/499,863, filed on May 3, 2023.

(51) Int. Cl. G06F 16/332

(52) U.S. Cl. CPC G06F 16/3326

(57) ABSTRACT

The present disclosure provides systems and methods for query expansion that utilize the generative abilities of machine-learned language models, such as, for example, so-called Large Language Models (LLMs).

### RELATED APPLICATIONS

This application claims priority to and the benefit of U.S. Provisional Patent Application No. 63/499,863, filed May 3, 2023. U.S. Provisional Patent Application No. 63/499,863 is hereby incorporated by reference in its entirety.

### FIELD

The present disclosure relates generally to information retrieval systems. More particularly, the present disclosure relates to prompting of large language models to perform expansion of queries for information retrieval systems.

### BACKGROUND

Information retrieval systems such as search engines are widely used for finding and accessing information on the Internet and other digital media. These systems typically rely on text-based queries submitted by users and return a set of search results based on the relevance and ranking of the indexed documents.

Query expansion is a class of techniques that improve the recall of information retrieval systems by adding additional terms to the original query. The expanded query may be able to recover relevant items (e.g., documents) that had no lexical overlap with the original query.

Traditional query expansion approaches are typically based on Pseudo-Relevance Feedback (PRF) techniques, which treat the set of retrieved documents from the original query as “pseudo-relevant” and uses those documents' contents to extract new query terms.

However, PRF-based approaches assume that the top retrieved documents are relevant to the query. In practice, the initial retrieved documents may not be perfectly aligned with the original query, especially if the query is short or ambiguous. As a result, PRF-based approaches may fail if the initial set of retrieved documents is not sufficiently relevant.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for information retrieval. The method includes obtaining, by a computing system comprising one or more computing devices, a query. The method includes generating, by the computing system, a model input comprising a combination of the query and a model prompt, wherein the model prompt comprises a chain of thought prompt that instructs a machine-learned language model to provide a rationale for its output. The method includes processing, by the computing system, the model input with the machine-learned language model to generate, as an output of the machine-learned language model, a model output. The method includes generating, by the computing system, an expanded query based on the query and the model output. The method includes providing, by the computing system, the expanded query as an input to an information retrieval system to receive a set of results as an output of the information retrieval system.

Another example aspect of the present disclosure is directed to a computing system for information retrieval. The computing system includes one or more processors and one or more non-transitory computer-readable media that collectively store instructions that, when executed by the one or more processors, cause the computing system to perform operations. The operations include obtaining, by the computing system, a query. The operations include generating, by the computing system, a model input comprising a combination of the query and a model prompt, wherein the model prompt comprises a zero-shot model prompt that specifies a task to be performed without providing any additional training data or examples. The operations include processing, by the computing system, the model input with a machine-learned language model to generate, as an output of the machine-learned language model, a model output. The operations include generating, by the computing system, an expanded query based on the query and the model output. The operations include providing, by the computing system, the expanded query as an input to an information retrieval system to receive a set of results as an output of the information retrieval system.

Another example aspect of the present disclosure is directed to one or more non-transitory computer-readable media that collectively store instructions that, when executed by a computing system, cause the computing system to perform operations. The operations include obtaining, by the computing system, a query. The operations include generating, by the computing system, a model input comprising a combination of the query and a model prompt, wherein the model prompt instructs a machine-learned language model to generate a list of keywords for the query. The operations include processing, by the computing system, the model input with the machine-learned language model to generate, as an output of the machine-learned language model, a model output. The operations include generating, by the computing system, an expanded query based on the query and the model output. The operations include providing, by the computing system, the expanded query as an input to an information retrieval system to receive a set of results as an output of the information retrieval system.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example query expansion system according to example aspects of the present disclosure.

FIG. 2 depicts a flow chart diagram of an example method to perform query expansion according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

### DETAILED DESCRIPTION

Generally, the present disclosure is directed to systems and methods for query expansion that utilize the generative abilities of machine-learned language models, such as, for example, so-called Large Language Models (LLMs). LLMs have seen a growing interest in the Information Retrieval (IR) community in recent years. They exhibit several properties, including the ability to answer questions and generate text, that make them powerful tools. The present disclosure leverages those generative abilities to generate useful query expansions.

More particularly, one goal of query expansion is to improve the relevance and accuracy of search results by incorporating additional information related to the original query. Traditional query expansion approaches, such as Pseudo-Relevance Feedback (PRF), rely on retrieving a set of documents that are considered to be relevant to the query and using them to expand the query.

In particular, example systems and methods described herein leverage different ways to prompt a language model and have it generate a variety of alternative and new terms for augmenting the original query. This means that, instead of relying solely on the knowledge within PRF documents or lexical knowledge bases, the proposed systems can incorporate the knowledge inherent in the language model.

Thus, the proposed approaches in this disclosure differ from traditional methods in that they utilize the generative and creative abilities of a language model, rather than relying on a set of pre-existing documents. This allows for the system to generate new and diverse search terms, rather than being limited to the terms found in a pre-existing set of documents. This approach leverages the knowledge inherent in the language model to generate relevant search terms that may not have been considered otherwise.

Aspects of the present disclosure are directed to different types of model prompts that can be used, including zero-shot prompts, Chain-of-Thought (CoT) prompts, and/or prompts that specifically instruct the model to generate additional keywords.

As one example, zero-shot prompts can be used to prompt the language model to generate additional query terms without providing any additional training data or examples. A zero-shot prompt can be more beneficial than a few-shot prompt because it can prompt the language model to generate expanded query terms without additional training data or examples, making it more flexible and adaptable to different query types and domains. In contrast, a few-shot prompt may not be flexible enough to guide generation of expanded query terms for different query types from different domains due to its limited, and potentially fixed expansion examples.

As another example, CoT prompts can be used to instruct the language model to break down the query into smaller steps and provide a large number of related terms. CoT prompts are particularly useful for query expansion, as they provide a structured approach to generating additional search terms. The use of different prompts, including CoT prompts, allows for a structured approach to generating additional search terms, further improving the accuracy of the results.

One of the technical benefits of the proposed approach is the ability to perform query expansion without relying on traditional methods such as Pseudo-Relevance Feedback (PRF). PRF approaches typically rely on retrieving a set of pseudo-relevant documents to expand queries, which can be time-consuming and may not always yield satisfactory results. By leveraging the generative and creative abilities of LLMs, this approach can provide more accurate and efficient query expansion.

Another technical benefit is to provide specific techniques for prompting the language model to generate additional query terms. One example form of prompt that demonstrates superior experimental results is the CoT prompt. This is because CoT prompts instruct the model to break down the query step-by-step, which generates a large number of keywords that can be used for query expansion.

The proposed prompting approaches are more effective than alternative techniques that leverage specially-trained, task-specific neural networks. Specifically, some alternative approaches to query expansion can leverage neural networks to generate or select expansion terms. However, these alternative approaches may require either training or fine-tuning a model. Training or fine-tuning a model consumes computational resources such as usage of processor cycles, memory space, and/or network bandwidth. Training or fine-tuning a model may also require bespoke training data, which may be time-consuming or challenging to generate.

The proposed prompting approaches are also more effective than a potential alternative approach that simply generates a single passage in response to the query. In particular, the proposed approaches can assist in generating a more comprehensive, yet targeted list of keywords that are directly related to the original query, rather than a lengthy passage that may potentially contain a number of irrelevant terms.

Specifically, one alternative approach can include prompting a language model to generate a full passage that is responsive to a query and then using the full passage to generate a model input. However, generating a full passage can be computationally expensive as the output may be lengthier. Furthermore, the passage may include a number of irrelevant terms. Generating a full passage in response to the query can be less focused and may include information that is not directly relevant to the user's information needs. This approach may lead to a larger set of expanded queries, but it may also lead to a higher number of irrelevant results. Additionally, generating full passages requires more computational resources and time, which can be a significant drawback in real-time search applications.

In contrast, an approach of prompting the machine-learned language model to generate a list of keywords for query expansion, as proposed herein, has several technical benefits. Firstly, generating a list of keywords allows for a more focused and targeted expansion of the original query. By providing a set of keywords that are directly related to the query, the expanded query can more accurately capture the user's intent and retrieve more relevant results.

Another technical benefit of generating a list of keywords is that it can be used to complement other query expansion techniques, such as pseudo-relevance feedback. By using both techniques together, the model can generate a set of keywords based on the original query and then use the pseudo-relevant documents to further expand the query with related terms. This approach can lead to a more comprehensive and relevant set of results.

The proposed approaches for query expansion also offers the advantage of enabling the use of smaller language models. In particular, by optimizing the trade-offs between model size and query expansion accuracy, the proposed approaches enable the development of query expansion systems that can operate on smaller, more computationally-efficient models. This conserves computational resources, as larger models tend to be more powerful but also more computationally expensive.

With reference now to the Figures, example embodiments of the present disclosure will be discussed in further detail.

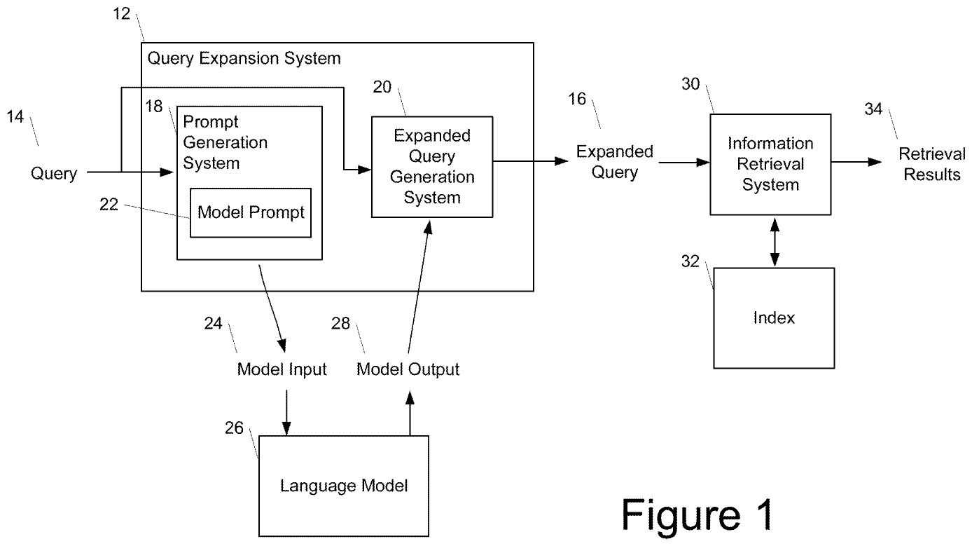

FIG. 1 illustrates an example query expansion system 12 according to example aspects of the present disclosure. The query expansion system 12 includes a prompt generation system 18 and an expanded query generation system 20. The query expansion system 12 can receive a query 14 and expanded to query 14 to generate an expanded query 16.

In particular, the query expansion system 12 can also include or be in cooperative communication with a machine-learned language model 26. The language model 26 can be a pre-trained model or a custom-trained model specific to the application domain. In some implementations, multiple language models 26 could be used in parallel to generate different types of output.

Referring still to FIG. 1, the query expansion system 12 can first obtain a query 14. The query 14 can be a request for information that is submitted to a search engine or information retrieval system 30. The query 14 can include a set of search terms or keywords that are used to retrieve relevant documents or information from a database or corpus.

The query 14 can be obtained from a user through various means, such as a search bar on a website or application, a voice command to a virtual assistant, or other input surfaces. The user may enter one or more search terms or phrases that describe the information they are looking for.

In some cases, a query 14 can also be automatically generated based on a user's behavior or preferences, such as their browsing history or location. Additionally, queries may be obtained from other sources, such as databases or other systems that store structured or unstructured data.

Next, the prompt generation system 18 can generate a model input 24 by combining the query 14 and a model prompt 22. The query expansion system 12 can then cause the model input 24 to be processed with a machine-learned language model 26 to generate a model output 28.

More particularly, the prompt generation system 18 can combine (e.g., concatenate) the query input 14 with the model prompt 22 to generate the model input 24.

The model prompt 22 can be a chain of thought prompt, a few-shot prompt, or a zero-shot prompt, as described herein. In some implementations the model prompt 22 is fixed ahead of time. In other implementations, the model prompt 22 can be generated dynamically based on the query 14 or other contextual factors. For example, if the query 14 contains a specific keyword, the prompt 22 could be tailored to elicit more information about that keyword.

In some implementations, the model prompt 22 can be a zero-shot model prompt 22. The zero-shot model prompt 22 can specify a task to be performed without providing any additional training data or examples. The zero-shot prompt 22 can include a description of the task, along with some relevant context or background information, and possibly some specific instructions for the model to follow. The model 26 then uses its pre-existing knowledge and language understanding capabilities to generate output that is relevant to the specified task.

The zero-shot model prompt 22 is designed to allow the language model 26 to generalize to new tasks without explicit training. The prompt 22 may be constructed as a natural language sentence that describes the task to be performed, and the language model 26 can use its pre-existing knowledge to generate an appropriate output 18. By using a zero-shot model prompt 22, the system 12 can enhance the flexibility and versatility of the language model 26, allowing it to perform a broader range of tasks, even in the absence of explicit training data.

One example model input 24 generated using a zero-shot model prompt 22 is as follows:

Write a passage that answers the following query: {query}Another example model input 24 generated using a zero-shot model prompt 22 is as follows:
Write a list of keywords for the following query: {query}

In some implementations, the model prompt 22 instructs the machine-learned language model 26 to generate a list of keywords for the query 14. The prompt 22 can be designed to extract relevant terms from the query 14, or to generate new terms that may be related to the query 14. The language model 26 can use its pre-existing knowledge to generate the list of keywords, which can be used to expand the query 14 and improve the accuracy and relevance of the search results. The keywords generated by the language model 26 can also be weighted or prioritized based on their relevance to the query 14, allowing the system 12 to refine the search results and provide a more accurate and relevant set of results to the user.

The machine-learned language model 26 used by the system 12 can be trained on a variety of data sources, including large corpora of text, structured knowledge bases, or domain-specific datasets. Additionally, the model prompt 22 can be customized to suit specific applications or domains, allowing the language model 26 to generate keywords that are relevant and specific to the application. In some implementations, the model prompt 22 may also include additional constraints or criteria to further refine the list of generated keywords. For example, the prompt 22 may instruct the language model 26 to generate only nouns or to prioritize certain types of terms over others. By using a machine-learned language model 26 to generate a list of keywords for the query 14, the system 12 can improve the accuracy and relevance of the search results.

A model prompt 22 that instructs the machine-learned language model 26 to generate a list of keywords for the query can be preferrable versus a model prompt that instructs the machine-learned language model 26 to generate a complete passage that responds to the query 14 because it allows for more flexibility and specificity in the query expansion process. When generating a passage in response to a query 14, the machine-learned language model 26 may generate a long and sometimes irrelevant passage may contain keywords that are not relevant to the specific information that the user is looking for.

On the other hand, generating a list of keywords for the query 14 allows focuses the generative aspect on terms that are directly relevant to the query 14. Thus, generating a list of keywords can provide more specificity to the query expansion process, allowing for a more targeted and accurate search.

Furthermore, generating a full passage in response to the query 14 may be computationally expensive, as the machine-learned language model 26 needs to generate a coherent and relevant passage. In contrast, generating a list of keywords is a simpler and quicker process, allowing for faster query expansion and retrieval of relevant results.

One example model input 24 generated using a prompt 22 that instructs the generation of keywords is as follows:

Write a list of keywords for the following query: {query}

Another example model input 24 generated using a prompt 22 that instructs the generation of keywords and also includes a number of few-shot examples is as follows:

Write a list of keywords for the given query:
Query: {query 1}
Keywords: {expansion 1}
Query: {query 2}
Keywords: {expansion 2}
Query: {query 3}
Keywords: {expansion 3}
Query: {query 4}
Keywords: {expansion 4}
Query: {query}

### Keywords:

Another example model input 24 generated using a prompt 22 that instructs the generation of keywords and also includes a number of PRF documents is as follows:

Write a list of keywords for the given query based on the context:

### Context: {PRF doc 1}

{PRF doc 2}
{PRF doc 3}
   Query: {query}

### Keywords:

In some implementations, the model prompt 22 comprises a chain of thought prompt that instructs the machine-learned language model 26 to provide a rationale for its output 28. A Chain of Thought (CoT) prompt is a type of prompt used to generate coherent and structured output from the language model 26. CoT prompts are designed to guide the model's processing and output 28 in a specific direction, causing the model 26 to generate output 28 that is more focused and organized than output generated from a more open-ended prompt.

The structure of a CoT prompt typically can include presenting the model 26 with a sequence of related prompts or questions, each building on the previous one. For example, the first prompt may ask the model 26 to generate a simple sentence or phrase related to a given topic, while subsequent prompts may ask the model 26 to elaborate on that initial response, provide more detail or examples, or address specific sub-topics related to the main topic.

Alternatively, a CoT prompt may simply instruct the model to “Give the rationale before answering.” In one example, a model input 24 generated using a CoT prompt 22 may have the following structure:

Answer the following query:
{query}
Give the rationale before answering.

Another example model input 24 generated using a CoT prompt 22 and a number of PRF documents may have the following structure:

Answer the following query based on the context:

### Context: {PRF doc 1}

{PRF doc 2}
{PRF doc 3}
   Query: {query}
   Give the rationale before answering.

By guiding the model's output in this way, CoT prompts can help to generate more coherent and structured output that is better suited for the specific application of information retrieval. The chain of thought prompt is designed to stimulate the language model 26 to include an explanation in its output 28 generated for a given input 24.

In some implementations, the model input 24 can further include one or more pseudo-relevance feedback documents that have been retrieved based on the query 14. The pseudo-relevance feedback documents can be obtained using traditional retrieval methods, such as the Vector Space Model (VSM), which retrieves documents based on their similarity to the query. Alternatively, more advanced retrieval methods, such as BM25 or language models, can be used to retrieve the feedback documents.

In some implementations, the pseudo-relevance feedback documents can be preprocessed before being combined with the query 14 and prompt 22 to form the model input 24. For example, the feedback documents can be cleaned of irrelevant content or transformed into a more suitable format for processing by the machine-learned language model 26. Additionally, the feedback documents can be selected based on various criteria, such as their relevance to the query 14 or their similarity to other feedback documents. The selection can be performed automatically or with human input.

The use of pseudo-relevance feedback documents can improve the performance of the query expansion system 12 by providing additional context for the machine-learned language model 26 to generate relevant expansion terms in the model output 28. By incorporating feedback documents into the model input 24, the machine-learned language model 26 can better understand the user's information needs and generate more accurate and useful expansion terms.

As one example, an example model input 24 generated using PRF documents is as follows:

Write a passage that answers the given query based on the context:

### Context: {PRF doc 1}

{PRF doc 2}
{PRF doc 3}
   Query: {query}

### Passage:

Another example model input 24 generated using PRF documents is as follows:

Write a list of keywords for the given query based on the context:

### Context: {PRF doc 1}

{PRF doc 2}
{PRF doc 3}
   Query: {query}

### Keywords:

Another example model input 24 generated using PRF documents is as follows:

Answer the following query based on the context:

### Context: {PRF doc 1}

{PRF doc 2}
{PRF doc 3}
   Query: {query}
   Give the rationale before answering.

In some example implementations, the language model 26 is a general-purpose machine-learned language model that has not been fine-tuned on a query expansion task. This general-purpose model is capable of generating natural language output 28 in response to a given input 24 without any additional training data or fine-tuning. Using a general-purpose machine-learned language model 26 provides several benefits over traditional query expansion techniques. First, the general-purpose model 26 can be used for a wide variety of query types and search domains, without the need for domain-specific training data. This allows the proposed approach to be easily adapted to new and emerging search domains.

Additionally, using a general-purpose model 26 reduces the need for manual labeling and annotation of training data, which can be time-consuming and expensive. This also reduces the risk of overfitting to the training data, as the general-purpose model 26 is not overfitted on any specific domain or dataset.

Referring still to FIG. 1, the expanded query generation system 20 can generate the expanded query 16 based on the query 14 and the model output 28 generated by the language model 26. The expanded query 16 can include additional terms or concepts related to the original query 14, as suggested by the model output 28. For example, if the query 14 is “best restaurants in New York”, the model output 28 could suggest additional concepts such as “Michelin-starred”, “outdoor dining”, or “delivery options”, which could be added to generate the expanded query 16.

In some implementations, the query expansion process can be formulated as follows: given a query q, the system 20 can generate the expanded query q′ that contains additional query terms that may help in retrieving relevant documents. In some implementations, since the model 28 output may be lengthy, the system 20 can repeat the original query 14 some number of times (e.g., 5) to upweigh their relative importance. More formally:

q′=Concat(q,q,q,q,q, LM(prompt_{q})),

where Concat is the string concatenation operator, q is the original query, LM is the language model 26 and prompt_{q} is the generated model input 24 based on the query 14 (and potentially side information like few-shot examples or PRF documents).

The expanded query 16 can be final query that is passed to the information retrieval system 30. The expanded query 16 can be a simple concatenation of the original query 14 and the additional terms suggested by the model output 28, or it could be a more complex expression that takes into account the relevance or importance of each term. For example, a weighting scheme could be used to prioritize certain terms over others based on their relevance.

The information retrieval system 30 can be a system that provides a set of results 34 in response to the expanded query 16. For example, the information retrieval system 30 can retrieve the results 34 from an index 32 of potential results. The information retrieval system 30 can be a search engine, a recommendation engine, or any other system that provides relevant information to the user. The results can be ranked based on their relevance to the expanded query 16, or based on other factors such as recency, popularity, or user preferences.

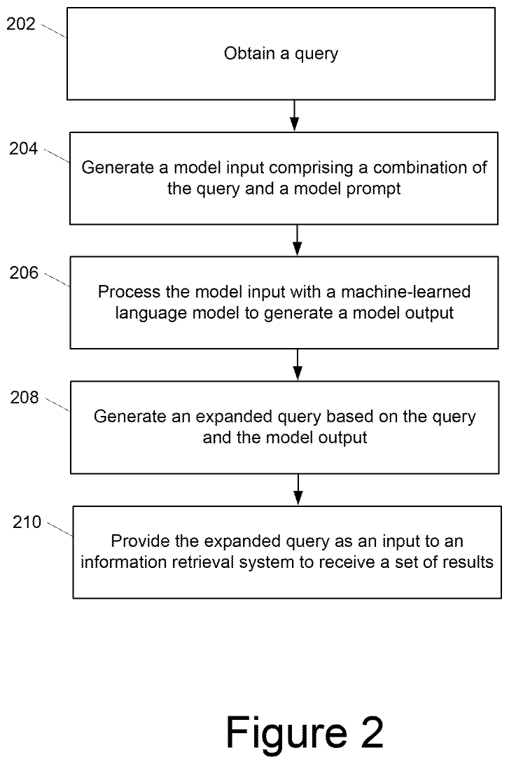

FIG. 2 provides a flow chart diagram of an example method for query expansion and information retrieval using a computing system. At 202, the method includes obtaining, by the computing system, a query. The query can be an input from a user through a user interface.

At 204, the computing system then generates a model input by combining the query input with a model prompt. Aspects of the present disclosure are directed to different types of model prompts that can be used, including zero-shot prompts, Chain-of-Thought (CoT) prompts, and/or prompts that specifically instruct the model to generate additional keywords.

At 206, the computing system then processes the model input using a machine-learned language model to generate a model output. The language model may have been trained on a large corpus of text. The language model can be a general-purpose model or may have been fine-tuned on a specific task or domain to improve its performance.

At 208, the computing system generates an expanded query based on the original query input and the model output. For example, the expanded query can be generated by the computing system using various techniques, such as concatenation, summarization, paraphrasing, or neural machine translation, that take into account the meaning and context of the input and output.

At 210, the computing system can then provide the expanded query as input to an information retrieval system, such as a search engine or database, to retrieve a set of results that are relevant to the original query input.

In some implementations, the computing system can rank the retrieved results using various algorithms, such as TF-IDF, BM25, or neural ranking models, that consider the relevance and quality of the results. The results can be displayed to the user in various formats, such as a list of URLs, a summary of the content, or a visual representation of the results.

The method can be implemented as a web service or an API using a suitable web framework. The computing system can be deployed on a variety of computing devices, such as servers, cloud platforms, and/or edge devices. The method enables users to obtain more relevant and accurate search results by leveraging the power of machine learning and natural language processing.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

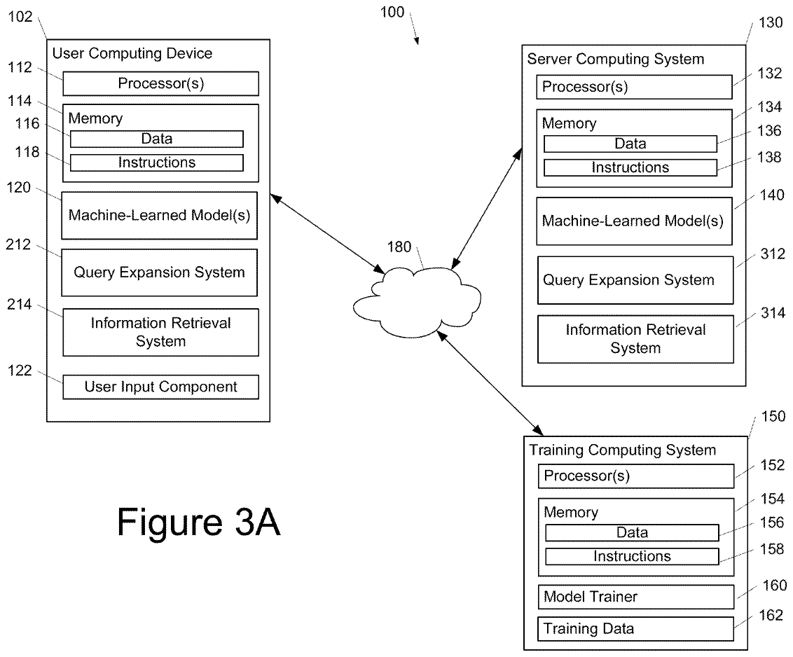

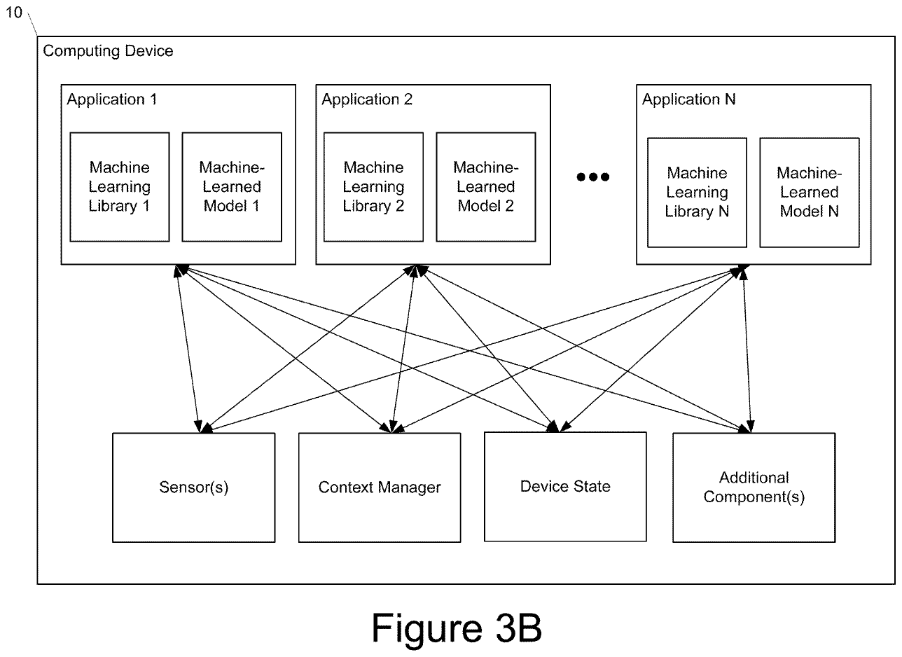

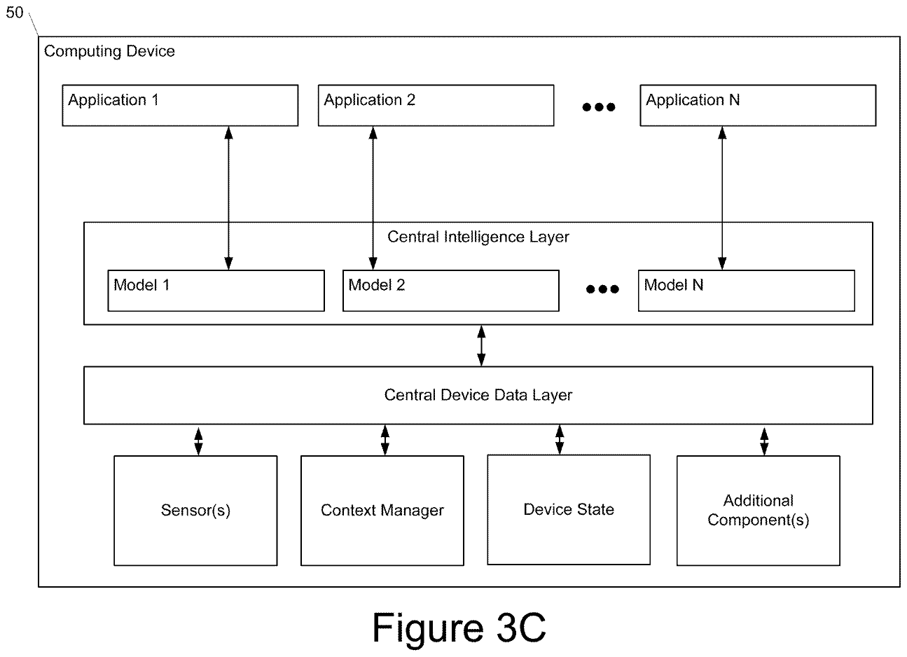

FIG. 3A depicts a block diagram of an example computing system 100 that performs query expansion and information retrieval according to example embodiments of the present disclosure. The example system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned language models 120. For example, the machine-learned language models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned language models 120 are discussed with reference to FIGS. 1 and 2.

In some implementations, the one or more machine-learned language models 120 can be received from the server computing system 130 over network 180, stored in the user computing device memory 114, and then used or otherwise implemented by the one or more processors 112. In some implementations, the user computing device 102 can implement multiple parallel instances of a single machine-learned language model 120 (e.g., to perform parallel query expansion across multiple instances of queries).

Additionally or alternatively, one or more machine-learned language models 140 can be included in or otherwise stored and implemented by the server computing system 130 that communicates with the user computing device 102 according to a client-server relationship. For example, the machine-learned language models 140 can be implemented by the server computing system 140 as a portion of a web service (e.g., a query expansion service). Thus, one or more models 120 can be stored and implemented at the user computing device 102 and/or one or more models 140 can be stored and implemented at the server computing system 130.

In some implementations, the user computing device 102 can include a query expansion system 212. Additionally or alternatively, the server computing system can include a query expansion system 312. Thus, some or all of the query expansion system 212 can be implemented at the user computing device 102 and/or some or all of the query expansion system 312 can be implemented at the server computing system 130. The query expansion system 212 and/or 312 can be the same or similar to the system 12 shown and discussed with reference to FIG. 1. The query expansion system 212 and/or 312 includes computer logic utilized to provide desired functionality. The query expansion system 212 and/or 312 can be implemented in hardware, firmware, and/or software controlling a general purpose processor. For example, in some implementations, the query expansion system 212 and/or 312 includes program files stored on a storage device, loaded into a memory and executed by one or more processors. In other implementations, the query expansion system 212 and/or 312 includes one or more sets of computer-executable instructions that are stored in a tangible computer-readable storage medium such as RAM, hard disk, or optical or magnetic media.

In some implementations, the user computing device 102 can include an information retrieval system 214. Additionally or alternatively, the server computing system can include an information retrieval system 314. Thus, some or all of the information retrieval system 214 can be implemented at the user computing device 102 and/or some or all of the information retrieval system 314 can be implemented at the server computing system 130. The information retrieval system 214 and/or 314 can be the same or similar to the system 30 shown and discussed with reference to FIG. 1. The information retrieval system 214 and/or 314 includes computer logic utilized to provide desired functionality. The information retrieval system 214 and/or 314 can be implemented in hardware, firmware, and/or software controlling a general purpose processor. For example, in some implementations, the information retrieval system 214 and/or 314 includes program files stored on a storage device, loaded into a memory and executed by one or more processors. In other implementations, the information retrieval system 214 and/or 314 includes one or more sets of computer-executable instructions that are stored in a tangible computer-readable storage medium such as RAM, hard disk, or optical or magnetic media.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned language models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

Example models 140 are discussed with reference to FIGS. 1 and 2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned language models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

In particular, although the Figures respectively depict steps performed in a particular order for purposes of illustration and discussion, the methods of the present disclosure are not limited to the particularly illustrated order or arrangement. The various steps of the methods described herein can be omitted, rearranged, combined, and/or adapted in various ways without deviating from the scope of the present disclosure.

1. A computer-implemented method for information retrieval, the method comprising:
obtaining, by a computing system comprising one or more computing devices, a query;
generating, by the computing system, a model input comprising a combination of the query and a model prompt, wherein the model prompt comprises a chain of thought prompt that instructs a machine-learned language model to provide a rationale for its output;
processing, by the computing system, the model input with the machine-learned language model to generate, as an output of the machine-learned language model, a model output;
generating, by the computing system, an expanded query based on the query and the model output; and
providing, by the computing system, the expanded query as an input to an information retrieval system to receive a set of results as an output of the information retrieval system.

2. The computer-implemented method of claim 1, wherein the machine-learned language model comprises a general-purpose model that has not been fine-tuned on a query expansion task.

3. The computer-implemented method of claim 1, wherein the model input further comprises one or more pseudo-relevance feedback documents that have been retrieved based on the query.

4. The computer-implemented method of claim 1, wherein generating, by the computing system, the expanded query based on the query and the model output comprises concatenating, by the computing system, the query and the model output to generate the expanded query.

5. A computing system for information retrieval, the computing system comprising:
one or more processors; and
one or more non-transitory computer-readable media that collectively store instructions that, when executed by the one or more processors, cause the computing system to perform operations, the operations comprising:
obtaining, by the computing system, a query;
generating, by the computing system, a model input comprising a combination of the query and a model prompt, wherein the model prompt comprises a zero-shot model prompt that specifies a task to be performed without providing any additional training data or examples;
processing, by the computing system, the model input with a machine-learned language model to generate, as an output of the machine-learned language model, a model output;
generating, by the computing system, an expanded query based on the query and the model output; and
providing, by the computing system, the expanded query as an input to an information retrieval system to receive a set of results as an output of the information retrieval system.

6. The computing system of claim 5, wherein the machine-learned language model comprises a general-purpose model that has not been fine-tuned on a query expansion task.

7. The computing system of claim 5, wherein the model input further comprises one or more pseudo-relevance feedback documents that have been retrieved based on the query.

8. The computing system of claim 5, wherein generating, by the computing system, the expanded query based on the query and the model output comprises concatenating, by the computing system, the query and the model output to generate the expanded query.

9. The computing system of claim 5, wherein the model prompt instructs the machine-learned language model to generate a list of keywords for the query.

10. The computing system of claim 5, wherein the model prompt instructs the machine-learned language model to generate a passage that responds to the query.

11. One or more non-transitory computer-readable media that collectively store instructions that, when executed by a computing system, cause the computing system to perform operations, the operations comprising:
obtaining, by the computing system, a query;
generating, by the computing system, a model input comprising a combination of the query and a model prompt, wherein the model prompt instructs a machine-learned language model to generate a list of keywords for the query;
processing, by the computing system, the model input with the machine-learned language model to generate, as an output of the machine-learned language model, a model output;
generating, by the computing system, an expanded query based on the query and the model output; and
providing, by the computing system, the expanded query as an input to an information retrieval system to receive a set of results as an output of the information retrieval system.

12. The one or more non-transitory computer-readable media of claim 11, wherein the machine-learned language model comprises a general-purpose model that has not been fine-tuned on a query expansion task.

13. The one or more non-transitory computer-readable media of claim 11, wherein the model input further comprises one or more pseudo-relevance feedback documents that have been retrieved based on the query.

14. The one or more non-transitory computer-readable media of claim 11, wherein generating, by the computing system, the expanded query based on the query and the model output comprises concatenating, by the computing system, the query and the model output to generate the expanded query.

15. The one or more non-transitory computer-readable media of claim 11, wherein the model prompt comprises a zero-shot model prompt that specifies a task to be performed without providing any additional training data or examples.

16. The computer-implemented method of claim 1, wherein the model output comprises a plurality of query expansion terms.

17. The computer-implemented method of claim 1, wherein the model output comprises an answer to the query.

18. The computer-implemented method of claim 1, wherein the model output comprises an answer to the query that follows a rationale supporting the answer.

19. The computer-implemented method of claim 1, wherein the information retrieval system is configured for sparse retrieval.

20. The computer-implemented method of claim 16, comprising:
retrieving one or more documents; and
providing the one or more documents in the model input, the one or more documents comprising the plurality of query expansion terms;
wherein the machine-learned language model attends over the plurality of query expansion terms in the one or more documents to generate the model output comprising the plurality of query expansion terms.
